(19) United States
(12) Patent Application Publication
(10) Pub. No.: US 2015/0198809 A1
(43) Pub. Date: Jul. 16, 2015

(54) VIRTUAL IMAGE DISPLAY MODULE AND OPTICAL LENS GROUP

(71) Applicants: Chung-Ting Wei, Hsin-Chu (TW); Chi-Tang Hsieh, Hsin-Chu (TW); Tzu-Hua Huang, Hsin-Chu (TW)

(72) Inventors: Chung-Ting Wei, Hsin-Chu (TW); Chi-Tang Hsieh, Hsin-Chu (TW); Tzu-Hua Huang, Hsin-Chu (TW)

(73) Assignee: CORETRONIC CORPORATION, Hsin-Chu (TW)

(21) Appl. No.: 14/506,697

(22) Filed: Oct. 6, 2014

(30) Foreign Application Priority Data
Jan. 16, 2014 (TW) 103101622

(51) Int. Cl. G02B 27/01; G02B 17/08; G02B 27/42

(52) U.S. Cl. CPC G02B 27/0172; G02B 27/4205; G02B 17/0896

(57) ABSTRACT

A virtual image display module, disposed in front of at least one eye of a user, including an image displaying unit and an optical lens group is provided. The image displaying unit provides an image beam. The optical lens group includes a reflecting unit, a first lens, a second lens and a diffractive optical element, which are disposed on the transmission path of the image beam. The first lens is disposed between the image displaying unit and the reflecting unit. The reflecting unit is disposed between the first lens and the second lens. The second lens is disposed between the reflecting unit and the eye. The diffractive optical element, the reflecting unit, the first lens and the second lens are independent optical elements, respectively. The image beam is transmitted to the eye through the first lens, the reflecting unit, the second lens and the diffractive optical element.

### CROSS-REFERENCE TO RELATED APPLICATION

This application claims the priority benefit of Taiwan application serial no. 103101622, filed on Jan. 16, 2014. The entirety of the above-mentioned patent application is hereby incorporated by reference herein and made a part of this specification.

### BACKGROUND OF THE INVENTION

1. Field of the Invention

The invention generally relates to a display module and an optical module, and more particularly to a virtual image display module and an optical lens group.

2. Description of Related Art

Along with the development of display technology and people's desire for high technology, techniques such as virtual reality and augmented reality have gradually become mature, and head mounted displays (HMDs) are kind of displays implementing the above techniques. The developing history of the HMDs can be traced back to U.S. military in the 1970s, which utilizes an optical projecting system to project the images or text messages of a display device into users' eyes. Recently, as the resolution of the micro-display becomes higher and dimension and power consumption of the micro-display becomes lower, the HMDs had also been developed into a portable display device. Other than military field, the display technology of the HMDs had also grown to occupy significant status in fields such as industrial fabrication, simulation training, three-dimensional display, medical, sports, navigation, and video games.

In general, HMDs usually utilize Near Eye Display (NED) to generate images. Since the NED is only coupled centimeters away from human eyes, and since HMDs are equipped on users' heads, how to design a light, thin, short optical system had become an important consideration during the design phase. At the same time, in order to reach high resolution and high color performances, the optical systems usually rely on increasing number of lenses to eliminate aberration and to increase the imaging quality. However, through such configuration, the volume and the weight are easily to cause discomfort for the users. Therefore, how to retain the image quality of the HMDs while fulfilling the requirement of compacted volume has become one of the important tasks in the related technology field.

U.S. Pat. No. 6,011,653, U.S. Pat. No. 7,884,985, U.S. Pat. No. 8,184,350, U.S. Pat. No. 6,903,875, U.S. Pat. No. 7,889,429, and U.S. Pat. No. 7,586,686 all disclose HMDs.

### SUMMARY OF THE INVENTION

The invention provides a virtual image display module and an optical lens group, which has the advantages of small size, excellent imaging quality, and low cost.

Other purposes and advantages of the invention can be better realized through the technical features as disclosed herein.

To achieve part of or all the purposes or other purposes of the invention, an embodiment of the invention provides a virtual image display module, adapted for disposing in front of at least one eye of a user. The virtual image display module includes an image displaying unit and an optical lens group. The image displaying unit is adapted for providing an image beam. The optical lens group includes a reflecting unit, a first lens, a second lens, and a diffractive optical element. The reflecting unit, the first lens, the second lens, and the diffractive optical element are disposed on the transmission path of the image beam. The first lens is disposed between the image displaying unit and the reflecting unit. The reflecting unit is disposed between the first lens and the second lens. The second lens is disposed between the reflecting unit and the eye. The diffractive optical element, the reflecting unit, the first lens, and the second lens can respectively be independent optical elements, but the invention is not limited thereto. The image beam is transmitted to the eye through the first lens, the reflecting unit, the second lens, and the diffractive optical element to display a virtual image.

To achieve part of or all the purposes or other purposes of the invention, an embodiment of the invention provides an optical lens group, adapted for transmitting an image beam to at least one eye of a user to display a virtual image.

In an embodiment of the invention, the first lens is adapted for moving relative to the image displaying unit to adjust the imaging position and the imaging size of the virtual image.

In an embodiment of the invention, the first lens is adapted for moving relative to the reflecting unit to adjust the imaging position and the imaging size of the virtual image.

In an embodiment of the invention, the relative distance between the optical lens group and the image displaying unit is adjusted to adjust the imaging position and the imaging size of the virtual image.

In an embodiment of the invention, one of the surfaces of the first lens is an aspheric surface.

In an embodiment of the invention, one of the surfaces of the second lens is an aspheric surface.

In an embodiment of the invention, the diffractive optical element is disposed between the image displaying unit and the first lens.

In an embodiment of the invention, the diffractive optical element is disposed between the first lens and the reflecting unit.

In an embodiment of the invention, the diffractive optical element is disposed between the reflecting unit and the second lens.

In an embodiment of the invention, the diffractive optical element is disposed between the second lens and the eye.

In an embodiment of the invention, there are spacing between the first lens, the reflecting unit, the second lens, and the diffractive optical element.

Accordingly, the embodiments of the invention have at least one of the following advantages or effects. The virtual image display module and the optical lens group according to embodiments of the invention can generate an excellent imaging quality while encompassing the structure of light in weight and small in volume at the same time through disposing the diffractive optical element. In addition, since the diffractive optical element, the reflecting unit, the first lens, and the second lens can respectively be independent structures of optical element, the purpose of reducing the weight of the virtual image display module and the optical lens group can be achieved. In addition, effects of increasing product fabrication yield and lowering the manufacturing cost can also be obtained.

To make the above features and advantages of the invention more comprehensible, several embodiments accompanied with drawings are described in detail as follows.

### BRIEF DESCRIPTION OF THE DRAWINGS

FIG. 1 is a schematic view of a virtual image display module according to an embodiment of the invention.

FIG. 2 is a schematic view of a virtual image display module according to another embodiment of the invention.

FIG. 3 is a schematic view of a virtual image display module according to the other embodiment of the invention.

FIG. 4 is a schematic view of a virtual image display module according to yet another embodiment of the invention.

### DESCRIPTION OF THE EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

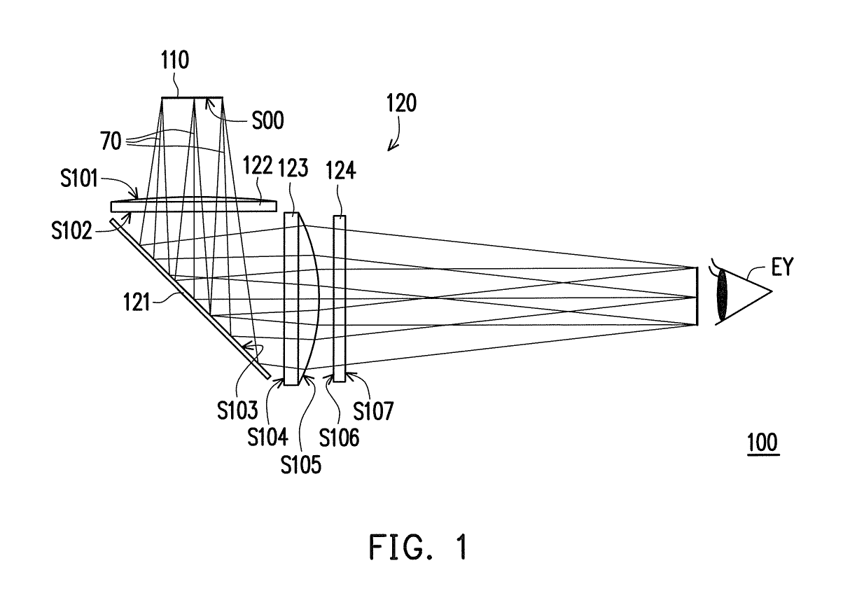

FIG. 1 is a schematic view of a virtual image display module according to an embodiment of the invention. Referring to FIG. 1, in the embodiment, a virtual image display module 100 is disposed in front of at least one eye EY of a user. The virtual image display module 100 includes an image displaying unit 110 and an optical lens group 120. The image displaying unit 110 provides an image beam 70. For example, in the embodiment, the image displaying unit 110 can be a micro Liquid Crystal Display panel (micro LCD panel), a Liquid Crystal on Silicon (LCOS) micro display or other types of micro displays, Digital Micromirror Device (DMD), but the invention is not limited thereto.

On the other hand, in the embodiment, the optical lens group 120 includes a reflecting unit 121, a first lens 122, a second lens 123, and a diffractive optical element 124. For instances, the reflecting unit 121 is, for example, a reflective mirror or a unit plated with reflective metal film, thus to allow the light transmission path of the image beam 70 to reflect, but the invention is not limited thereto. In another embodiment, the reflecting unit 121 can also be a beam splitter with transreflective property, which provides partial light transmission and partial light reflection function to the incident light, thereby allowing part of the image beam 70 to reflect and transmit to an eye EY.

At the same time, the image beam of the surrounding environment can also be transmitted to the eye EY through reflecting unit 121, allowing the display module 100 to include a see-through function.

Moreover, in the embodiment, the material of the first lens 122 and the second lens 123 is, for example, optical plastic material, thereby to reduce the weight of the optical lens group 120 and the virtual image display module 100. Specifically, in the embodiment, the refractive power of the first lens 122 and the second lens 123 are positive, for example. In addition, in the embodiment, one of the surfaces of the first lens 122 is an aspheric surface, and one of the surfaces of the second lens 123 is an aspheric surface. For example, a surface S101 of the first lens 122 and a surface S105 of the second lens 123 are aspheric surfaces. As such, by designing one of the surfaces of the first lens 122 as an aspheric surface and by designing one of the surfaces of the second lens 123 as an aspheric surface, the aberration of the optical lens group 120 and the virtual image display module 100 can be reduced.

On the other hand, since general lens cannot focus on the same plane due to color light with different wavelength, chromatic aberration would take place. In order to overcome the above problem of chromatic aberration, in the embodiment, diffractive optical element 124 which allows the image beam 70 to generate a diffractive effect such as a diffractive grating, a holographic optical element, a binary optical element, or a diffractive fresnel lens can be used as the diffractive optical element 124 to eliminate chromatic aberration. As such, the optical lens group 120 can include excellent chromatic aberration correction effect and superior imaging quality, and at the same time, also encompasses the structure of being light in weight and small in volume.

Moreover, in the embodiment, the diffractive optical element 124, the reflecting unit 121, the first lens 122, and the second lens 123 are respectively independent optical elements. As shown in FIG. 1, in the embodiment, there are spacing respectively between the first lens 122 and the reflecting unit 121, the reflecting unit 121 and the second lens 123, and the second lens 123 and the diffractive optical element 124. In other words, in the embodiment, unlike the structural design of general prism, the optical lens group 120 and the virtual image display module 100 in the embodiment can achieve the purpose of reducing the weight through separated lens type structural design. Moreover, in the embodiment, since the diffractive optical element 124 and other optical elements (for example, the reflecting unit 121, the first lens 122, and the second lens 123) are manufactured separately, the shape and the size of the diffractive optical element 124 are not limited by other optical elements. For example, in the embodiment, the diffractive optical element 124 can be formed on a circular plate (not illustrated); as such, the simplicity of the mold fabrication and the yield of the molding product can be increased to achieve the purpose of reducing manufacturing cost.

Referring to FIG. 1 again, specifically, in the embodiment, the reflecting unit 121, the first lens 122, the second lens 123, and the diffractive optical element 124 are disposed on the transmission path of the image beam 70. The first lens 122 is disposed between the image displaying unit 110 and the reflecting unit 121. The reflecting unit 121 is disposed between the first lens 122 and the second lens 123. The second lens 123 is disposed between the reflecting unit 121 and the eye EY of the user. The diffractive optical element 124 is disposed between the second lens 123 and the eye EY of the user. Furthermore, after the image beam 70 is emitted from the image displaying unit 110, the image beam 70 can be transmitted to the reflecting unit 121 through the first lens 122. Subsequently, the transmission path of the image beam 70 is reflected by the reflecting unit 121 to reduce the axial distance of the optical lens group 120, thereby allowing the optical lens group 120 and the virtual image display module 100 to have a thin structural design. For example, in the embodiment, the angle of the reflection of the transmission path of the image beam 70 is approximately 90 degrees, but the invention is not limited thereto. In other embodiments, the angle of the reflection of the transmission path of the image beam 70 can fall in the range of 70 degree to 110 degree. Next, the image beam 70 reflected by the reflecting unit 121 can transmit to the eye EY of the user through the second lens 123 and the diffractive optical element 124 to display a virtual image. It is worth to note that the above parameters are only utilized as examples for explanation, and the invention is not limited thereto.

Furthermore, in the embodiment, the users can move the first lens 122 relative to the image displaying unit 110 (or reflecting unit 121) through a control unit (not illustrated) base on personal preferences. Alternatively, the user can adjust the relative distance between the optical lens group 120 and the image displaying unit 110 in order to adjust the imaging position and imaging size of the virtual image, thereby to increase the usage convenience of the virtual image display module 100. On the other hand, for near-sighted or far-sighted users, the virtual image display device can also allow the first lens 122 to move relative to the image displaying unit 110 (or reflecting unit 121) through a control unit (not illustrated) to adapt to different diopter of user's eye EY. Alternatively, while adjusting the relative distance between the optical lens group 120 and the image displaying unit 110, different diopter of user's eye EY can be also adapted. Therefore, in the embodiment, near-sighted or far-sighted users are not required to wear extra correction glasses and are still able to clearly observe the image displayed by the display device.

Based on the above descriptions, by disposing the diffractive optical element 124, the virtual image display module 100 and the optical lens group 120 can generate an excellent imaging quality while encompassing the structure of light in weight and small in volume. Moreover, through the structure such that the diffractive optical element 124, the reflecting unit 121, the first lens 122, and the second lens 123 are respectively independent optical elements, the purpose of reducing the weight of the virtual image display module 100 and the optical lens group 120 can be achieved. At the same time, the effect of increasing product fabrication yield and decreasing manufacturing cost can also be obtained. On the other hand, for the virtual display module 100 and the optical lens group 120, by adjusting the distance between the first lens 122 relative to the image displaying unit 110 (or reflecting unit 121), or by adjusting the relative distance between the optical lens group 120 and the image displaying unit 110 to adjust the imaging position and the imaging size of the virtual image, the usage convenience of the virtual image display module 100 can be increased, and at the same time, near-sighted or far-sighted users are not required to wear extra correction glasses and are still able to clearly observe the image displayed by the virtual image display device.

An embodiment of the virtual image display module 100 is provided below. However, the data presented below is not used for limiting the invention, and those skilled in the art may suitably modify parameters or settings of the following embodiment with reference of the invention without departing from the scope or spirit of the invention.

TABLE 1

| | | Curvature | Spacing | |
|---|---|---|---|---|
| Surface | Surface Type | Radius (mm) | (mm) | Remarks |
| S00 | Spherical | Infinity | 5.4 | Image displaying |
| | | | | unit 110 |
| S101 | Aspheric | 19.1 | 1.0 | First lens 122 |
| S102 | Spherical | Infinity | 6.2 | |
| S103 | Spherical | Infinity | 6.2 | Reflecting unit 121 |
| S104 | Spherical | Infinity | 2.5 | Second lens 123 |
| S105 | Aspheric | −12.6 | 0.5 | |
| S106 | Spherical | Infinity | 0.7 | Diffractive optical |
| | | | | element 124 |
| S107 | Spherical | Infinity | 25 | |

In Table 1, the curvature radius is the curvature radius of each of the surfaces, and the spacing is the distance between two adjacent surfaces. For example, the spacing of the surface S101 is the distance between the surface S101 and a surface S102 on the optical axis. The corresponding thickness of the lens in remarks column can be found referring to the values corresponding to the spacing in the same row. Moreover, the surface S00 is the display surface of the image displaying unit 110. It is worth to mention that the curvature radius of the spherical surface of the surface S00 is infinity because of the optics simulation software with reasonable deviation. The surface S101 is the surface of the first lens 122 which faces toward the image display unit 110, the surface S102 is the surface of the first lens 122 which faces toward the reflecting unit 121, and a surface S103 is the reflecting surface of the reflecting unit 121. Surfaces S104 and S105 are two surfaces of the second lens 123. Surfaces S106 and S107 are two surfaces of the diffractive optical element 124.

As described above, the surfaces S101 and S105 are aspheric surfaces, and the formula of aspheric surfaces is as follows:

$$z = \frac{{cr}^{2}}{1 + \sqrt{1 - ( 1 + k ) {c}^{2} {r}^{2}}} + {α}_{1} {r}^{2} + {α}_{2} {r}^{4} + {α}_{3} {r}^{6} ,$$

wherein z is the offset value in optical axis direction. c is the curvature of the osculating sphere; namely, the reciprocal of the curvature radius close to the optical axis (for example, the curvature radii of S101 and S105 in Table 1). k is the conic constant. r is the height of the aspheric surface; namely, the height from the center of the lens to the edge of the lens. As shown in the formula, different r corresponds to different z values. α₁, α₂, α₃ are aspheric coefficient. The aspheric coefficient and the k value of the surfaces S101 and S105 are shown in Table 2:

TABLE 2

| Surface | k | α₁ | α₂ | α₃ |
|---|---|---|---|---|
| S101 | −12.6 | 0 | −6.70E−05 | 0 |
| S105 | −2 | 0 | −7.30E−05 | 0 |

As described above, the surface S106 is a diffractive surface, and the formula of the diffractive surface is as follows:

$$Φ = M {\sum }_{i = 1}^{N} {A}_{i} {ρ}^{2 i} ,$$

wherein Φ is phase profile function, ρ is the height of normalized radial aperture, Ai is the even power order coefficient of the height of normalized radial aperture (i.e. ρ), M is diffraction order. As shown in the formula above, different value of ρ would corresponds to different value of Φ. The coefficient Ai for each order of ρ value of the surface S106 is shown in Table 3:

TABLE 3

| Surface | A2 | A4 | A6 |
|---|---|---|---|
| S106 | −700 | 35 | −7.6 |

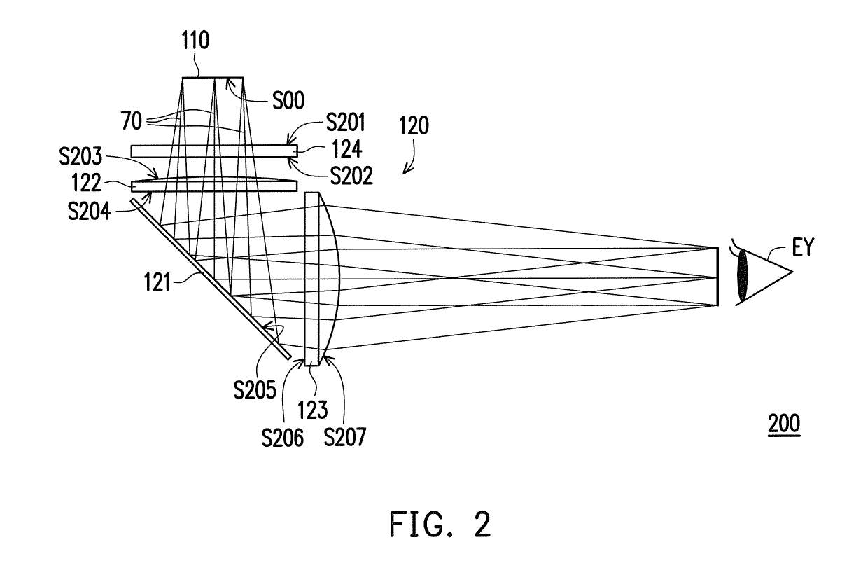

Moreover, although in the aforementioned optical lens group 120, the diffractive optical element 124 is disposed between the second lens 123 and the eye EY of the user, the invention is not limited thereto. In other embodiments, the diffractive optical element 124 can also be disposed on other locations, and further explanation accompanied by FIGS. 2-4 will be presented below.

FIG. 2 is a schematic view of a virtual image display module according to another embodiment of the invention. Referring to FIG. 2, a virtual image display module 200 in the embodiment is similar to the virtual image display module 100 in FIG. 1, and the differences between the two are as follows. In the virtual image display module 200 according to the embodiment, the diffractive optical element 124 is disposed between the image displaying unit 110 and the first lens 122. Moreover, in the embodiment, the actuation mechanism of the virtual image display module 200 is similar to the actuation mechanism of the virtual image display module 100. The related detail may be referred to the previous paragraphs and may not be repeated herein. In addition, since the structure of the virtual image display module 200 is similar to that of the virtual image display module 100, it can also yield an excellent imaging quality while achieving the structure of being light in weight and small in volume through disposing the diffractive optical element 124. Therefore, the virtual image display module 200 also encompasses the advantages as mentioned in the virtual image display module 100, and will not be repeated herein.

An embodiment of the virtual image display module 200 is provided below. However, the data presented below is not used for limiting the invention, and those skilled in the art may suitably modify parameters or settings of the following embodiment with reference of the invention without departing from the scope or spirit of the invention.

TABLE 4

| | | Curvature | Spacing | |
|---|---|---|---|---|
| Surface | Surface Type | Radius (mm) | (mm) | Remarks |
| S00 | Spherical | Infinity | 5.2 | Image displaying |
| | | | | unit 110 |
| S201 | Spherical | Infinity | 0.7 | Diffractive optical |
| | | | | element 124 |
| S202 | Spherical | Infinity | 1.0 | |
| S203 | Aspheric | 31 | 1.0 | First lens 122 |
| S204 | Spherical | Infinity | 6.2 | |
| S205 | Spherical | Infinity | 6.2 | Reflecting unit 121 |
| S206 | Spherical | Infinity | 2.5 | Second lens 123 |
| S207 | Aspheric | −11.8 | 25 | |

In Table 4, the meaning represented by curvature radius and spacing is the same as that of in Table 1, which may be referred to the explanations for Table 1, and thus may not be repeated herein. In addition, surface S201 is the surface of the diffractive optical element 124 which faces toward the image display unit 110 and surface S202 is the surface of the diffractive optical element 124 which faces toward the first lens 122. Surfaces S203 and 5204 are two surfaces of the first lens 122. Surface S205 is the reflecting surface of the reflecting unit 121. Surfaces 5206 and S207 are two surfaces of the second lens 123.

As described above, the surfaces S203 and S207 are aspheric surfaces, the surface S202 is a diffractive surface, and the formula thereof is the same as the formula suitable for Table 1 presented above. The physical meanings of each of the parameters may be referred to the explanations for Table 1, and may not be repeated herein. The aspheric coefficient and other parameters of the surfaces S203 and S207 and each of the parameters of the diffractive surface of the surface S202 are shown in Table 5 and Table 6:

TABLE 5

| Surface | k | α₁ | α₂ | α₃ |
|---|---|---|---|---|
| S203 | 25.5 | 0 | −4.30E−04 | 0 |
| S207 | −1.7 | 0 | −7.80E−05 | 0 |

TABLE 6

| Surface | A2 | A4 | A6 |
|---|---|---|---|
| S202 | −2700 | −350 | 820 |

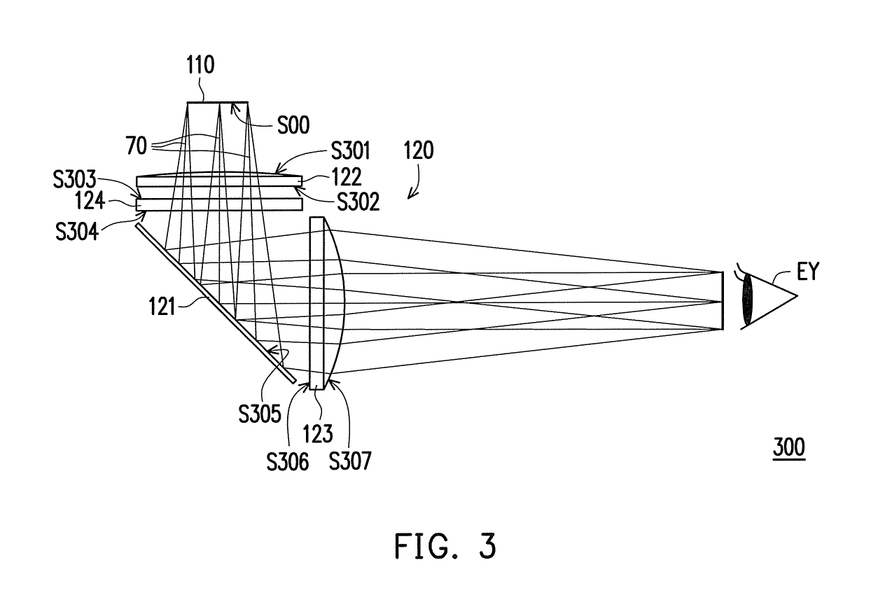

FIG. 3 is a schematic view of a virtual image display module according to the other embodiment of the invention. Referring to FIG. 3, a virtual image display module 300 in the embodiment is similar to the virtual image display module 100 in FIG. 1, and the differences between the two are as follows. In the virtual image display module 300 according to the embodiment, the diffractive optical element 124 is disposed between the first lens 122 and the reflecting unit 121. In the embodiment, the actuation mechanism of the virtual image display module 300 is similar to the actuation mechanism of the virtual image display module 100. The related detail may be referred to the previous paragraphs and may not be repeated herein. In addition, since the structure of the virtual image display module 300 is similar to that of the virtual image display module 100, it can also yield an excellent imaging quality while achieving the structure of being light in weight and small in volume through disposing the diffractive optical element 124. Therefore, the virtual image display module 300 also encompasses the advantages as mentioned in the virtual image display module 100, and will not be repeated herein.

An embodiment of the virtual image display module 300 is provided below. However, the data presented below is not used for limiting the invention, and those skilled in the art may suitably modify parameters or settings of the following embodiment with reference of the invention without departing from the scope or spirit of the invention.

TABLE 7

| | | Curvature | Spacing | |
|---|---|---|---|---|
| Surface | Surface Type | Radius (mm) | (mm) | Remarks |
| S00 | Spherical | Infinity | 5.6 | Image displaying |
| | | | | unit 110 |
| S301 | Aspheric | 24 | 1.4 | First lens 122 |
| S302 | Spherical | Infinity | 0.5 | |
| S303 | Spherical | Infinity | 0.7 | Diffractive optical |
| | | | | element 124 |
| S304 | Spherical | Infinity | 6 | |
| S305 | Spherical | Infinity | 6 | Reflecting unit 121 |
| S306 | Spherical | Infinity | 2.5 | Second lens 123 |
| S307 | Aspheric | −11.7 | 25 | |

In Table 7, the meaning represented by curvature radius and spacing is the same as that of in Table 1, which may be referred to the explanations for Table 1, and thus may not be repeated herein. In addition, surface S301 is the surface of the first lens 122 which faces toward the image display unit 110 and surface S302 is the surface of the first lens 122 which faces toward the diffractive optical element 124. Surfaces S303 and S304 are two surfaces of the diffractive optical element 124. Surface S305 is the reflecting surface of the reflecting unit 121. Surfaces S306 and S307 are two surfaces of the second lens 123.

As described above, the surfaces S301 and S307 are aspheric surfaces, the surface S304 is a diffractive surface, and the formula thereof is the same as the formula suitable for Table 1 presented above. The physical meanings of each of the parameters may be referred to the explanations for Table 1, and may not be repeated herein. The aspheric coefficient and other parameters of the surfaces S301 and S307 and each of the parameters of the diffractive surface of the surface S304 are shown in Table 8 and Table 9:

TABLE 8

| Surface | k | α₁ | A₂ | α₃ |
|---|---|---|---|---|
| S301 | 19 | 0 | −6.80E−04 | 0 |
| S307 | −1.6 | 0 | −7.30E−05 | 0 |

TABLE 9

| Surface | A2 | A4 | A6 |
|---|---|---|---|
| S304 | −1800 | −100 | 600 |

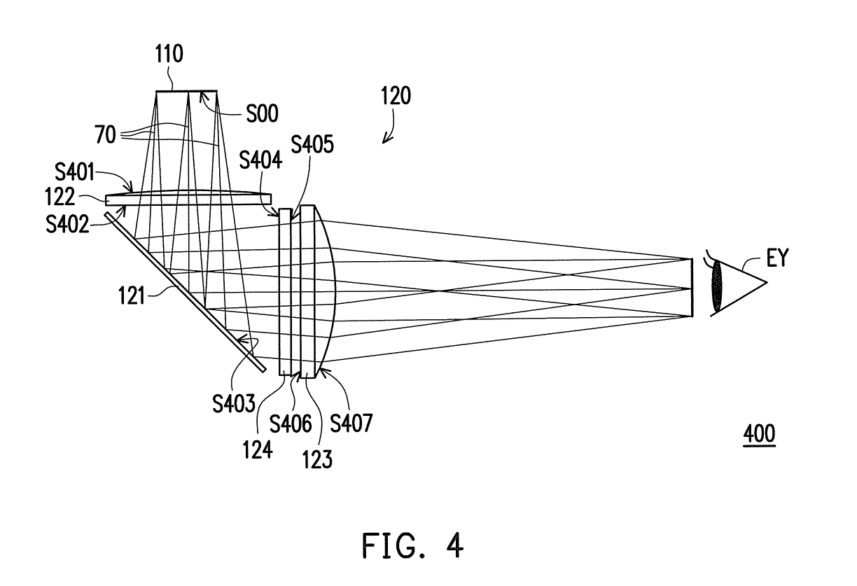

FIG. 4 is a schematic view of a virtual image display module according to yet another embodiment of the invention. Referring to FIG. 4, a virtual image display module 400 in the embodiment is similar to the virtual image display module 100 in FIG. 1, and the differences between the two are as follows. In the virtual image display module 400 according to the embodiment, the diffractive optical element 124 is disposed between the reflecting unit 121 and the second lens 123. In the embodiment, the actuation mechanism of the virtual image display module 400 is similar to the actuation mechanism of the virtual image display module 100. The related detail may be referred to the previous paragraphs and may not be repeated herein. In addition, since the structure of the virtual image display module 400 is similar to that of the virtual image display module 100, it can also yield an excellent imaging quality while achieving the structure of being light in weight and small in volume through disposing the diffractive optical element 124. Therefore, the virtual image display module 400 also encompasses the advantages as mentioned in the virtual image display module 100, and will not be repeated herein.

An embodiment of the virtual image display module 400 is provided below. However, the data presented below is not used for limiting the invention, and those skilled in the art may suitably modify parameters or settings of the following embodiment with reference of the invention without departing from the scope or spirit of the invention.

TABLE 10

| | | Curvature | Spacing | |
|---|---|---|---|---|
| Surface | Surface Type | Radius (mm) | (mm) | Remarks |
| S00 | Spherical | Infinity | 5.4 | Image displaying |
| | | | | unit 110 |
| S401 | Aspheric | 17 | 1.0 | First lens 122 |
| S402 | Spherical | Infinity | 6 | |
| S403 | Spherical | Infinity | 6 | Reflecting unit 121 |
| S404 | Spherical | Infinity | 0.7 | Diffractive optical |
| | | | | element 124 |
| S405 | Spherical | Infinity | 0.5 | |
| S406 | Spherical | Infinity | 2.5 | Second lens 123 |
| S407 | Aspheric | −12.8 | 25 | |

In Table 10, the meaning represented by curvature radius and spacing is the same as that of in Table 1, which may be referred to the explanations for Table 1, and thus may not be repeated herein. In addition, surface S401 is the surface of the first lens 122 which faces toward the image display unit 110 and surface S402 is the surface of the first lens 122 which faces toward the diffractive optical element 124. Surface S403 is the reflecting surface of the reflecting unit 121. Surfaces S404 and S405 are two surfaces of the diffractive optical element 124. Surfaces S406 and S407 are two surfaces of the second lens 123.

As described above, the surfaces S401 and S407 are aspheric surfaces, the surface S404 is a diffractive surface, and the formula thereof is the same as the formula suitable for Table 1 presented above. The physical meanings of each of the parameters may be referred to the explanations for Table 1, and may not be repeated herein. The aspheric coefficient and other parameters of the surfaces S401 and S407 and each of the parameters of the diffractive surface of the surface S404 are shown in Table 11 and Table 12:

TABLE 11

| Surface | k | α₁ | α₂ | α₃ |
|---|---|---|---|---|
| S401 | 6 | 0 | −5.00E−04 | 0 |
| S407 | −1 | 0 | −2.00E−05 | 0 |

TABLE 12

| Surface | A2 | A4 | A6 |
|---|---|---|---|
| S404 | −800 | 140 | −40 |

Accordingly, in the virtual image display module and the optical lens group of the invention, by replacing low dispersion glasses lenses with diffractive optical elements, an excellent imaging quality through eliminating chromatic aberration can be achieved while encompassing the structure of light in weight and small in volume. Moreover, through the structure such that the diffractive optical element, the reflecting unit, the first lens, and the second lens are respectively independent optical elements, the purpose of reducing the weight of the virtual image display module and the optical lens group can be achieved. At the same time, the effect of increasing product fabrication yield and decreasing manufacturing cost can also be obtained. On the other hand, for the virtual display module and the optical lens group, by adjusting the distance between the first lens relative to the image displaying unit (or reflecting unit), or by adjusting the relative distance between the optical lens group and the image displaying unit to adjust the imaging position and the imaging size of the virtual image, the usage convenience of the virtual image display module can be increased, and at the same time, near-sighted or far-sighted users are not required to wear extra correction glasses and are still able to clearly observe the image displayed by the virtual image display device.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure.

Moreover, terms such as “first”, “second”, etc. used in the specification or claims should be understood as a nomenclature and should not be construed as giving the limitation on the number of the elements modified by such nomenclature unless specific number has been given.

What is claimed is:

1. A virtual image display module, adapted for disposing in front of at least one eye of a user, comprising:
an image displaying unit, adapted for providing an image beam; and
an optical lens group, comprising:
a reflecting unit, located on the transmission path of the image beam;
a first lens, disposed on the transmission path of the image beam and located between the image displaying unit and the reflecting unit;
a second lens, disposed on the transmission path of the image beam, wherein the reflecting unit is located between the first lens and the second lens, and the second lens is located between the reflecting unit and the eye; and
a diffractive optical element, located on the transmission path of the image beam, wherein the diffractive optical element, the reflecting unit, the first lens, and the second lens are respectively independent optical elements, and the image beam transmits to the eye through the first lens, the reflecting unit, the second lens, and the diffractive optical element to display a virtual image.

2. The virtual image display module according to claim 1, wherein the first lens is adapted for moving relative to the image displaying unit to adjust the imaging position and imaging size of the virtual image.

3. The virtual image display module according to claim 1, wherein the optical lens group is adapted for moving relative to the image displaying unit to adjust the imaging position and imaging size of the virtual image.

4. The virtual image display module according to claim 1, wherein one of the surfaces of the first lens is an aspheric surface.

5. The virtual image display module according to claim 1, wherein one of the surfaces of the second lens is an aspheric surface.

6. The virtual image display module according to claim 1, wherein the diffractive optical element is located between the image displaying unit and the first lens.

7. The virtual image display module according to claim 1, wherein the diffractive optical element is located between the first lens and the reflecting unit.

8. The virtual image display module according to claim 1, wherein the diffractive optical element is located between the reflecting unit and the second lens.

9. The virtual image display module according to claim 1, wherein the diffractive optical element is located between the second lens and the eye.

10. The virtual image display module according to claim 1, wherein there are spacing between the diffractive optical element, the reflecting unit, the first lens, and the second lens.

11. An optical lens group, adapted for transmitting an image beam to at least one eye of a user to display a virtual image, comprising:
a reflecting unit, located on the transmission path of the image beam;
a first lens, disposed on the transmission path of the image beam;
a second lens, disposed on the transmission path of the image beam, wherein the reflecting unit is located between the first lens and the second lens, and the second lens is located between the reflecting unit and the eye; and
a diffractive optical element, located on the transmission path of the image beam, wherein the diffractive optical element, the reflecting unit, the first lens, and the second lens are respectively independent optical elements, and the image beam transmits to the eye through the first lens, the reflecting unit, the second lens, and the diffractive optical element to display a virtual image.

12. The optical lens group according to claim 11, wherein the first lens is adapted for moving relative to the reflecting unit to adjust the imaging position and imaging size of the virtual image.

13. The optical lens group according to claim 11, wherein the optical lens group is adapted for moving relative to the image displaying unit to adjust the imaging position and imaging size of the virtual image.

14. The optical lens group according to claim 11, wherein one of the surfaces of the first lens is an aspheric surface.

15. The optical lens group according to claim 11, wherein one of the surfaces of the second lens is an aspheric surface.

16. The optical lens group according to claim 11, wherein the diffractive optical element is located between the first lens and the reflecting unit.

17. The optical lens group according to claim 11, wherein the diffractive optical element is located between the reflecting unit and the second lens.

18. The virtual image display module according to claim 11, wherein the diffractive optical element is located between the second lens and the eye.

19. The virtual image display module according to claim 11, wherein there are spacing between the diffractive optical element, the reflecting unit, the first lens, and the second lens.
